(19) United States
(12) Patent Application Publication
(10) Pub. No.: US 2024/0160197 A1
(43) Pub. Date: May 16, 2024

(54) HYBRID WORKING MODE ON INDUSTRIAL FLOOR

(71) Applicant: INTERNATIONAL BUSINESS MACHINES CORPORATION, ARMONK, NY (US)

(72) Inventors: Sarbajit K. Rakshit, Kolkata (IN); Vinod A. Valecha, Pune (IN)

(21) Appl. No.: 18/055,042

(22) Filed: Nov. 14, 2022

(51) Int. Cl. G05B 19/418; G06T 19/00

(52) U.S. Cl. CPC G05B 19/4188; G05B 19/4185; G05B 19/41885; G06T 19/006

(57) ABSTRACT

A method, computer system, and a computer program product for evaluating remote commands is provided. The present invention may include receiving data for a physical ecosystem. The present invention may include generating a digital twin of the physical ecosystem based on the data received. The present invention may include identifying one or more correlated activities using the digital twin. The present invention may include receiving a remote command. The present invention may include determining whether to execute the remote command by simulating the remote command using the digital twin and the one or more correlated activities.

### BACKGROUND

The present invention relates generally to the field of computing, and more particularly to Virtual Reality (VR) systems.

Hybrid performance of work roles on an industrial floor may involve a set of workers present physically and another set of workers operating remotely through a VR system. The set of workers operating remotely through the VR system may need to be aware of the set of workers present physically when operating machinery and/or submitting remote commands. Accordingly, remote commands may require validation prior to being executed to avoid conflict between workers present physically and workers operating remotely.

Furthermore, validation of remote commands and/or other safety concerns may be facilitated by intelligently designating areas within the industrial floor specifically to workers present physically and/or workers operating remotely.

### SUMMARY

Embodiments of the present invention disclose a method, computer system, and a computer program product for evaluating remote commands. The present invention may include receiving data for a physical ecosystem. The present invention may include generating a digital twin of the physical ecosystem based on the data received. The present invention may include identifying one or more correlated activities using the digital twin. The present invention may include receiving a remote command. The present invention may include determining whether to execute the remote command by simulating the remote command using the digital twin and the one or more correlated activities.

In another embodiment, the method may include determining the remote command cannot be executed based on the simulation of the remote command using the digital twin, notifying a user the remote command cannot be executed, and providing one or more recommendations to the user.

In a further embodiment, the method may include generating a virtual working environment for the one or more remote workers, wherein each of the one or more remote workers are assigned a designated workspace within the virtual working environment.

In yet another embodiment, the method may include integrating one or more physical workers into the virtual working environment.

In addition to a method, additional embodiments are directed to a computer system and a computer program product for determining whether to execute a remote command based on a simulation of the remote command using a digital twin and one or more identified correlated activities.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for evaluating remote commands according to at least one embodiment.

### DETAILED DESCRIPTION

The following described exemplary embodiments provide a system, method and program product for verifying remote commands. As such, the present embodiment has the capacity to improve the technical field of VR systems and hybrid working environments by determining whether to execute a remote command based on a simulation of the remote command using a digital twin and one or more identified correlated activities. More specifically, the present invention may include receiving data for a physical ecosystem. The present invention may include generating a digital twin of the physical ecosystem based on the data received. The present invention may include identifying one or more correlated activities using the digital twin. The present invention may include receiving a remote command. The present invention may include determining whether to execute the remote command by simulating the remote command using the digital twin and the one or more correlated activities.

As described previously, Hybrid performance of work roles on an industrial floor may involve a set of workers present physically and another set of workers operating remotely through a VR system. The set of workers operating remotely through the VR system may need to be aware of the set of workers present physically when operating machinery and/or submitting remote commands. Accordingly, remote commands may require validation prior to being executed to avoid conflict between workers present physically and workers operating remotely.

Furthermore, validation of remote commands and/or other safety concerns may be facilitated by intelligently designating areas within the industrial floor specifically to workers present physically and/or workers operating remotely.

Therefore, it may be advantageous to, among other things, receive data for a physical ecosystem, generate a digital twin of the physical ecosystem based on data received, identify one or more correlated activities using the digital twin, receive a remote command, determine whether to execute the remote command by simulating the remote command using the digital twin and the one or more correlated activities.

According to at least one embodiment, the present invention may improve conflict mitigation between remote and in-person workers by creating a virtual working environment for remote workers using a digital twin generated from data received for a physical ecosystem and integrating in-person workers such that the remote workers may visualize the in-person workers of the physical ecosystem.

According to at least one embodiment, the present invention may improve conflict mitigation between remote and in-person workers by receiving a remote command from one of a plurality of remote workers and determining whether to execute the remote command by simulating the remote command based on one or more correlated activities using the digital twin generated for the physical ecosystem.

According to at least one embodiment, the present invention may improve the safety of in-person workers by determining whether to execute the remote command by simulating the remote command based on one or more correlated activities using the digital twin generated for the physical ecosystem and providing feedback to the remote worker responsible for the remote command as to why the remote command may not be executed and one or more recommendations as to executing the remote command.

According to at least one embodiment, the present invention may improve the efficiency of an industrial floor by understanding the activities associated with a remote command and storing those correlated activities in a knowledge corpus.

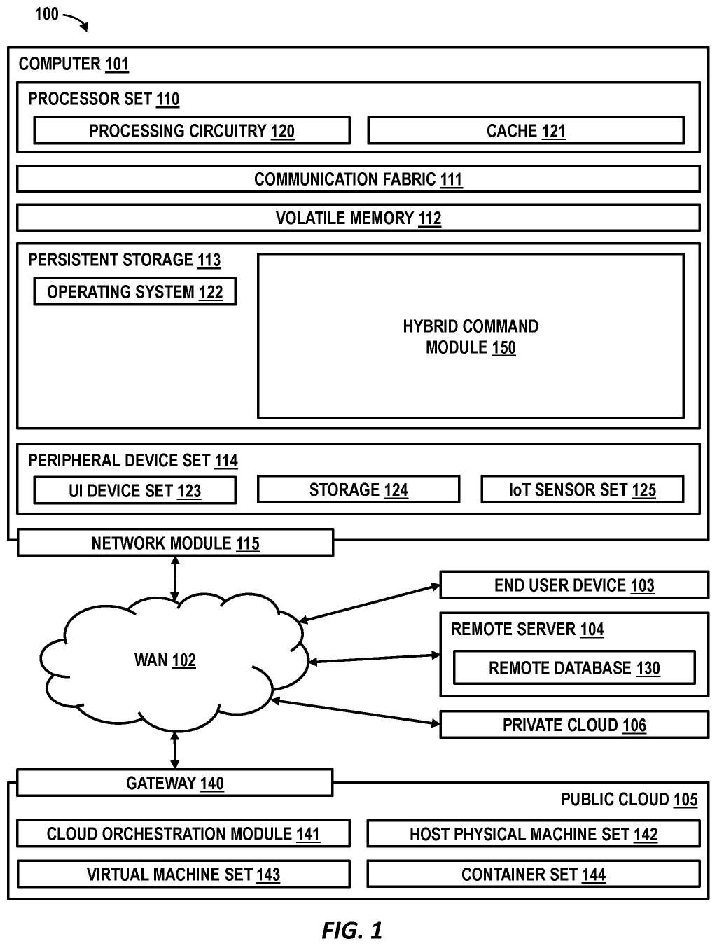

Referring to FIG. 1, Computing environment 100 contains an example of an environment for the execution of at least some of the computer code involved in performing the inventive methods, such as determining whether to execute a remote command based on a simulation of the remote command using a digital twin and one or more identified correlated activities using the hybrid command module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

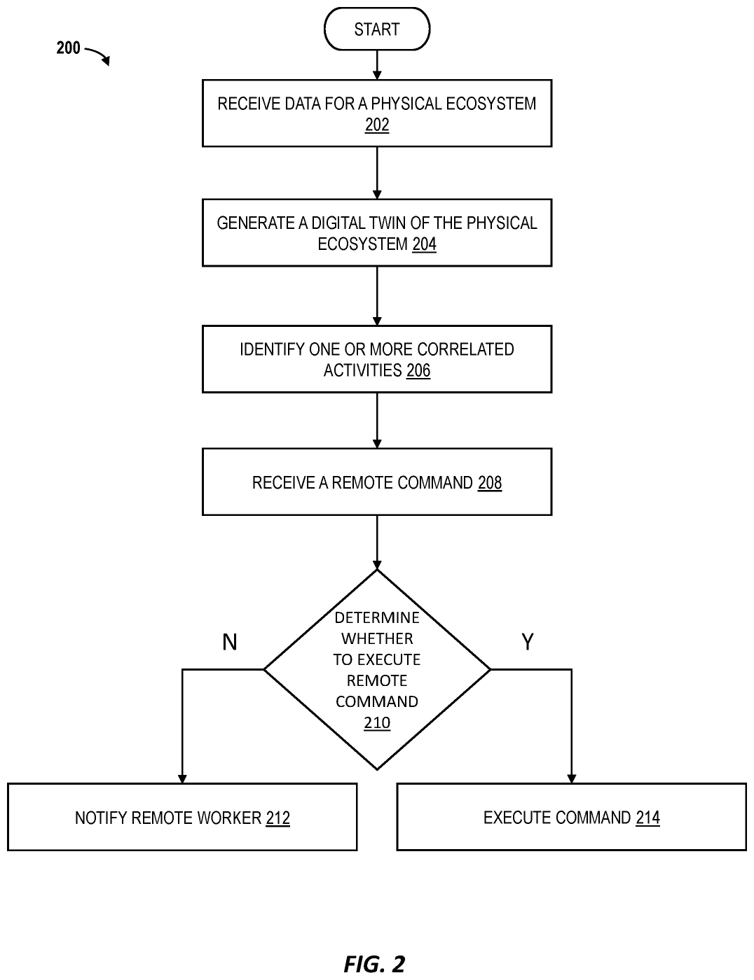

According to the present embodiment, the computer environment 100 may use the hybrid command module 150 to determining whether to execute a remote command based on a simulation of the remote command using a digital twin and one or more identified correlated activities. The hybrid command method is explained in more detail below with respect to FIG. 2.

Referring now to FIG. 2, an operational flowchart illustrating the exemplary hybrid command process 200 used by the hybrid command module 150 according to at least one embodiment is depicted.

At 202, the hybrid command module 150 receives data for a physical ecosystem. The physical ecosystem may be an industrial floor, warehouse, manufacturing plant, and/or other factory. The physical ecosystem may be comprised of a plurality of physical assets. The physical assets comprising the physical ecosystem may be operated by a plurality of individuals, wherein the plurality of individuals may include one or more physical workers and/or one or more remote workers (e.g., users). As will be explained in more detail below, the one or more physical workers may be present in the physical ecosystem and the one or more remote workers (e.g., users) may operate the physical assets within the physical ecosystem utilizing remote commands executed within a Virtual Reality (VR) system.

Data received for the physical ecosystem may include, but is not limited to including, square footage, property size, location, material used in construction, window types, year built, blueprints, roofing details, architecture, information on appliances, occupancy, ventilation systems, airflow details, as well as additional data from one or more IoT devices associated with the physical ecosystem. The one or more IoT devices associated with the physical ecosystem may include, but are not limited to including, thermostats, lighting, air quality, smoke detectors, carbon monoxide detectors, irrigations systems, security, air conditioning, movement, and ventilation systems, amongst other IoT devices. The one or more IoT devices may perform readings of the environment within the physical ecosystem. The IoT devices may be connected to one or more sensors (e.g., temperature sensors, motion sensors, humidity sensors, pressure sensors, accelerometers, gas sensors, multi-purpose IoT sensors, amongst other sensors) to perform the one or more readings. The data from the one or more readings performed by the IoT devices may be stored on the IoT device itself and/or broadcasted to a knowledge corpus (e.g., database 130).

The hybrid command module 150 may also receive images and/or 3D scans of assets comprising the physical ecosystem. The physical assets may include, but are not limited to including, turning machines, shapers and/or planers, drilling machines, milling machines, grinding machines, power saws, presses, various robotic systems, amongst other industrial machines. The hybrid command module 150 may receive and/or access data with respect to the physical ecosystem and/or the one or more physical assets comprising the physical ecosystem from the one or more physical workers working within the physical ecosystem, one or more IoT devices associated with the asset, images and/or 3D scans of the asset, a brand, model number, bill of materials, product codes, part numbers, design specifications, production processes, engineering information, material composition of parts, product configuration, materials used, manufacturing/process parameters, service history, diagnostics data, asset modifications, odometer readings, telematics data, recall campaigns, product details, accident reports, a brand, model number, bill of materials, product codes, part numbers, design specifications, production processes, engineering information, material composition of parts, quality control measures, metadata from the one or more physical assets, smart wearable data from the one or more physical workers operating the asset, and/or one or more publicly available resources, amongst other methods of receiving and/or accessing data. The hybrid command module 150 may store data received and/or accessed with respect to each asset and/or the physical ecosystem in the knowledge corpus (e.g., database 130).

The hybrid command module 150 may also receive and/or access data from an entity associated with the physical ecosystem, the one or more remote workers (e.g., users), one or more physical workers, and/or another authorized party associated with the entity. The entity and/or one or more remote workers (e.g., users) may provide data through a user interface displayed by the hybrid command module 150 on an EUD 103, UI device set 123 of the peripheral device set 114, and/or another device. The hybrid command module 150 may display the user interface to the user on the EUD 103, UI device set 123 of the peripheral device set 114, and/or another device, in at least an internet browser, dedicated software application, and/or as an integration with a third party software application. As will be explained in more detail below with respect to at least steps 204 and 208 the EUD 103, UI device set 123 of the peripheral device set 114, and/or other device may be a Virtual Reality (VR) compatible device which may enable one or more remote workers (e.g., users) to execute remote commands within the physical ecosystem. This data may include, but is not limited to including, internal documentation, procedures, checklists, equipment information, operating instructions, training plans, skills assessments, instructional videos, diagrams, business process event logs, task management plans, types of activities performed on the industrial floor. The data received and/or accessed may be stored in a knowledge corpus (e.g., database 130). As will be explained in more detail below with respect to at least step 206, the hybrid command module 150 may utilize at least the data received and/or accessed from the user in identifying one or more correlated activities.

The hybrid command module 150 may also receive data with respect to tracking and/or authenticating the presence of the one or more physical workers of the physical ecosystem. As will be explained in more detail below with respect to at least step 204, the hybrid command module 150 may integrate the one or more physical workers present in the physical ecosystem into the digital twin based on one or more authentication methods, such as, but not limited to, thermal imagery, smart wearable devices, IoT devices, integrated work calendaring, Global Positioning Systems (GPS) of one or more devices associated with a physical worker, amongst other authentication methods. As will be explained in more detail below with respect to step 204, data received from the user utilized in running and/or operating each asset of the physical ecosystem as well as other data stored in the knowledge corpus (e.g., database 130) may be utilized in generating a digital representation of the physical ecosystem and/or the one or more assets comprising the physical ecosystem. The digital representation may be a digital twin. As will be explained in more detail below with respect to step 206, the hybrid command module 150 may utilize the data received and/or accessed at step 202 and the digital twin generated at step 204 in identifying one or more correlated activities.

At 204, the hybrid command module 150 generates a digital twin of the physical ecosystem. The digital twin may include a digital representation of each of the one or more assets comprising the physical ecosystem. A digital twin may be a virtual representation of an object or system which may be updated using real-time data, and may be utilized in at least, simulations, machine learning, and/or reasoning in aiding informed decision making.

The digital twin of the physical ecosystem may represent the current state of each of the plurality of machines and/or equipment comprising the industrial floor. The hybrid command module 150 may continuously receive and/or access the data described in step 202 and/or additional data such that the hybrid command module may update the digital twin of physical ecosystem in real time to correspond to at least the current state of each of the plurality of machines and/or equipment and integrate the real time positional locations of the one or more physical workers. The hybrid command module 150 may integrate the real time positioning of the one or more physical workers using an avatar representing each of the in-person and/or physical workers such that the avatar may be performing an activity within the digital twin environment corresponding to the activity being performed in the physical ecosystem. The hybrid command module 150 may also incorporate updates, new capabilities, enhancements, maintenance, and/or other upgrades into the digital twin.

In an embodiment, the hybrid command module 150 may generate a virtual working environment for one or more remote workers. The virtual working environment may be unique for each of the one or more remote workers, such that each of the one or more remote workers may be assigned a designated workspace based on access limitations and/or other parameters designated by the entity associated with the physical ecosystem. Each of the one or more remote workers may log in to the VR system using the EUD 103 and/or other device and the hybrid command module 150 may identify the designated workspace for each of the one or more remote workers (e.g., users). The designated workspace may be determined based on job role, data stored in the knowledge corpus (e.g., database 130), access limitations, amongst other relevant information. The hybrid command module 150 may also display relevant information to a remote worker (e.g., user) using the user interface, the VR system, and/or the EUD 103. For example, within an industrial floor certain business process may require multiple operations to be performed in succession and/or simultaneously. The hybrid command module 150 may alert remote workers (e.g., users) as to other activities being performed within the industrial floor based on data received.

At 206, the hybrid command module 150 identifies one or more correlated activities. The hybrid command module 150 may identify the one or more correlated activities using the digital twin and/or the data received at step 202. The hybrid command module 150 may identify the one or more correlated activities for each of a plurality of commands which may be executed by a physical worker and/or a remote worker. The one or more correlated activities may include, activities performed as a result of a command, resources used, emissions, amongst other byproducts of the command being executed.

The hybrid command module 150 may identify the one or more correlated activities utilizing one or more linguistic analysis techniques in analyzing the data received at step 202. The one or more linguistic analysis techniques may include, but are not limited to including, a machine learning model with Natural Language Processing (NLP), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States, and/or other countries), IBM Watson® Natural Language Understanding, IBM Watson® Natural Language Classifier, amongst other implementations. The one or more correlated activities may be all the activities which may be performed upon the execution of a command. The hybrid command module 150 may utilize the one or more linguistic analysis techniques in identifying the correlated activities, ordering, co-located activities, duration and/or wait times, acting resources and/or roles, business objectives, associated values, states, milestones, decisions, and/or process outcomes, amongst other aspects of the correlated activities. Co-located activities may be related activities that if performed influence another place within the physical ecosystem. The hybrid command module 150 may also identify the one or more correlated activities based on manual feed received directly from the user.

The hybrid command module 150 may also identify the one or more correlated activities using the digital twin. For example, the hybrid command module 150 may simulate a command through the digital twin performing all the activities in a workflow associated with the command such that the hybrid command module 150 may determine which physical assets may be utilized for each command, byproducts of a command, emissions and/or heat generated by a command and which areas of the physical ecosystem are utilized by each command. As will be explained in more detail below, when the hybrid command module 150 receives a remote command the hybrid command module 150 may be able to simulate the command through the digital twin while simultaneously considering activities being performed and/or locations of physical workers within the physical ecosystem in determining whether to execute the remote command.

At 208, the hybrid command module 150 receives a remote command. The hybrid command module 150 may receive the remote command from a user selecting and/or entering the command within a display and/or another user interface through at least the EUD 103, UI device set 123 of the peripheral device set 114, another device, and/or directly through the VR system. The user may be at least one of the one or more remote workers described at step 202. The remote command may include, but is not limited to including, a business process, safety procedure, evacuation procedure, starting a machine, stopping a machine, performing certain operations on a machine through physical gestures, amongst other commands which may executed by a remote worker in the physical ecosystem.

In an embodiment, the hybrid command module 150 may receive the remote command by intercepting a command attempting to be executed within the VR system by a user (e.g., remote worker). In this embodiment, the hybrid command module 150 may intercept the command and notify the user (e.g., remote worker) the command is being reviewed prior to execution.

At 210, the hybrid command module 150 determines whether to execute the remote command. The hybrid command module 150 may determine whether to execute the remote command by simulating the remote command using the digital twin and the one or more correlated activities identified at step 206.

The hybrid command module 150 may utilize one or more machine learning models and/or one or more simulation methods in simulating the remote command. The one or more machine learning models may include, but are not limited to including, Convolutional Neural Networks (CNNs), Artificial Neural Networks (ANNs), Support Vector Machine (SVM), K-Nearest Neighbors (KNN), Naïve Bayes, and/or a hybrid model. The hybrid model may be trained to combine the predictions of two or more machine learning models. The one or more simulation models may include, but are not limited to including, a Monte Carlo simulation process, agent based simulation model, discrete event simulation model, and/or a system dynamic simulation model, amongst other simulation methods. The hybrid command module 150 may additionally utilize a statistical program such as IBM's SPSS® (SPSS® and all SPSS-based trademarks are trademarks or registered trademarks of International Business Machines Corporation in the United States, and/or other countries), or Statistical Product and Service Solution, in optimizing the one or more simulation methods.

The hybrid command module 150 may simulate the remote command through digital twin using the one or more correlated activities to the remote command received in determining whether to execute the remote command. The hybrid command module 150 may also consider the tracking data received at step 202 for the one or more physical workers within the physical ecosystem in determining the safety of the one or more physical workers who may be affected by the execution of the remote command. For example, the remote command may be received from a remote worker (e.g., user) using the EUD 103 in the user interface. The remote command may include one or more correlated activities which based on the locations of the one or more physical workers may not be able to be executed for safety reasons and/or because a required physical asset and/or machine is currently being utilized for a different business process on the industrial floor.

If the hybrid command module 150 determines the remote command may not be executed, the hybrid command module 150 proceeds to step 212. If the hybrid command module 150 determines the remote command may be executed, the hybrid command module 150 proceeds to step 214.

At 212, if the hybrid command module 150 determines the remote command may not be executed, the hybrid command module notifies the remote worker (e.g., user). The hybrid command module 150 may notify the remote worker (e.g., user) in the user interface using the EUD 103.

The hybrid command module 150 may also provide one or more recommendations to the remote worker (e.g., user). The one or more recommendations may include, but are not limited to including, why the remote command may not be executed, when the hybrid command module 150 projects the remote worker (e.g., user) may execute the remote command, bottlenecks identified in a workflow, recommendations as to reducing long duration and/or wait times in command and/or activity executions, Key Performance Indicators (KPIs), amongst other recommendations. The hybrid command module 150 may continue to monitor the physical ecosystem and/or industrial floor and alert the user (e.g., remote worker) when the remote command may be cleared for execution.

The ontology adaptation module 150 may continue to monitor the industrial floor and the data accessed and/or received based on workflow. The ontology adaptation module 150 may store the data accessed and/or received based on workflow in the knowledge corpus (e.g., database 130). The ontology adaptation module 150 may utilize the recommendations and/or new business process ontologies (e.g., new process ontologies) implemented by the user as well as the data accessed and/or received based on workflow to improve the one or more recommendations and/or provide new recommendations based on at least updates, new capabilities, enhancements, and/or maintenance to the user.

At 214, if the hybrid command module 150 determines the remote command may be executed, the hybrid command module 150 executes the remote command. The hybrid command module 150 may execute the remote command my transmitting instructions to each of the one or more physical assets within the physical ecosystem responsible for carrying out each of the one or more correlated activities to the remote command.

The hybrid command module 150 may additionally provide an alert to one or more physical workers and/or other remote workers that the command may be executed. The alert may include safety instructions and/or other commands which may not be executed while the remote command is being executed.

The hybrid command module 150 may continuously monitor the one or more physical assets in their performance of the one or more correlated activities of the remote command. The hybrid command module 150 may monitor the one or more physical assets based on real time data received from the physical assets themselves, IoT devices within the physical ecosystem, and/or devices associated with the one or more physical workers.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for evaluating remote commands, the method comprising:
receiving data for a physical ecosystem;
generating a digital twin of the physical ecosystem based on the data received;
identifying one or more correlated activities using the digital twin;
receiving a remote command; and
determining whether to execute the remote command by simulating the remote command using the digital twin and the one or more correlated activities.

2. The method of claim 1, further comprising:
determining the remote command cannot be executed based on the simulation of the remote command using the digital twin;
notifying a user the remote command cannot be executed; and
providing one or more recommendations to the user.

3. The method of claim 1, further comprising:
generating a virtual working environment for one or more remote workers, wherein each of the one or more remote workers are assigned a designated workspace within the virtual working environment.

4. The method of claim 3, further comprising:
integrating one or more physical workers into the virtual working environment.

5. The method of claim 1, wherein simulating the remote command using the digital twin utilizes one or more machine learning algorithms.

6. The method of claim 1, wherein identifying one or more correlated activities utilizes one or more linguistic analysis techniques in analyzing the data received for the physical ecosystem.

7. The method of claim 1, wherein the remote command is received from a user using a user interface, the user being a remote worker.

8. A computer system for evaluating remote commands, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving data for a physical ecosystem;
generating a digital twin of the physical ecosystem based on the data received;
identifying one or more correlated activities using the digital twin;
receiving a remote command; and
determining whether to execute the remote command by simulating the remote command using the digital twin and the one or more correlated activities.

9. The computer system of claim 8, further comprising:
determining the remote command cannot be executed based on the simulation of the remote command using the digital twin;
notifying a user the remote command cannot be executed; and
providing one or more recommendations to the user.

10. The computer system of claim 8, further comprising:
generating a virtual working environment for one or more remote workers, wherein each of the one or more remote workers are assigned a designated workspace within the virtual working environment.

11. The computer system of claim 10, further comprising:
integrating one or more physical workers into the virtual working environment.

12. The computer system of claim 8, wherein simulating the remote command using the digital twin utilizes one or more machine learning algorithms.

13. The computer system of claim 8, wherein identifying one or more correlated activities utilizes one or more linguistic analysis techniques in analyzing the data received for the physical ecosystem.

14. The computer system of claim 8, wherein the remote command is received from a user using a user interface, the user being a remote worker.

15. A computer program product for evaluating remote commands, comprising:
one or more non-transitory computer-readable storage media and program instructions stored on at least one of the one or more tangible storage media, the program instructions executable by a processor to cause the processor to perform a method comprising:
receiving data for a physical ecosystem;
generating a digital twin of the physical ecosystem based on the data received;
identifying one or more correlated activities using the digital twin;
receiving a remote command; and
determining whether to execute the remote command by simulating the remote command using the digital twin and the one or more correlated activities.

16. The computer program product of claim 15, further comprising:
determining the remote command cannot be executed based on the simulation of the remote command using the digital twin;
notifying a user the remote command cannot be executed; and
providing one or more recommendations to the user.

17. The computer program product of claim 15, further comprising:
generating a virtual working environment for one or more remote workers, wherein each of the one or more remote workers are assigned a designated workspace within the virtual working environment.

18. The computer program product of claim 17, further comprising:
integrating one or more physical workers into the virtual working environment.

19. The computer program product of claim 15, wherein simulating the remote command using the digital twin utilizes one or more machine learning algorithms.

20. The computer program product of claim 15, wherein identifying one or more correlated activities utilizes one or more linguistic analysis techniques in analyzing the data received for the physical ecosystem.
